(19) United States
(12) Patent Application Publication
(10) Pub. No.: US 2016/0037332 A1
(43) Pub. Date: Feb. 4, 2016

(54) METHOD AND APPARATUS FOR CONTROLLING HOME APPLIANCES OVER LTE

(71) Applicant: Cellco Partnership d/b/a Verizon Wireless, Basking Ridge, NJ (US)

(72) Inventors: Christian Egeler, Basking Ridge, NJ (US); Shiva Narayanabhatla, Basking Ridge, NJ (US); Mauricio Pati Caldeira de Andrada, South Plainfield, NJ (US)

(21) Appl. No.: 14/445,193

(22) Filed: Jul. 29, 2014

(51) Int. Cl. H04W 8/22; G08C 17/02

(52) U.S. Cl. CPC H04W 8/22; G08C 17/02

(57) ABSTRACT

A computer includes a processor, a network communication interface controlled by the processor, and a memory accessible by the processor. Programming is stored in the memory which configures the computer as a network server to support configuration of a user interface on a mobile device for control of an appliance. The network server: 1) receives and stores registration information from the appliance, which includes an identification of the appliance and information for configuring the user interface to control the appliance, 2) receives, over a cellular network, a request from a mobile device which includes the identification of the appliance, and 3) transmits, over the cellular network, the configuration information to the mobile device which is used to configure the mobile device to display the user interface for wirelessly controlling the appliance on the mobile device.

### BACKGROUND

In recent years, controlling home appliances by way of mobile devices has become increasingly popular. However, most conventional systems that implement mobile device control of home appliances are restricted in the configuration process, and cannot perform ad-hoc configuration and control.

For example, conventional systems may control a home appliance (e.g. thermostat) that is wirelessly connected to the user's home internet connection via a WiFi access point. A mobile phone of the user may then download a software application that has been specifically designed to control that specific home appliance. To control another device in the home, such as a television or set-top box (particularly if sold by a different and/or or offered from a different manufacturer), the user may need to download another software application that has been specifically designed to control that other type of home appliance. Each application provides a different configuration specific to the particular appliance or source of appliances. To the extent that each such application requires internal configuration, e.g. to allow a particular mobile device and/or user to control the thermostat or television installed in the user's particular premises from their particular mobile device, each application would require the user to configure the respective application for the user and the appliance at the user's premises.

Thus, conventional solutions implement very rigid configuration processes where specific software must be downloaded by the mobile phone in order to control an appliance configured to operate using that software. Ad-hoc configuration of mobile phones to control appliances is not possible with these systems.

### BRIEF DESCRIPTION OF THE DRAWINGS

The figures depict one or more implementations in accordance with the present teachings by way of example only, not by way of limitation. In the figures, like reference numbers refer to same or similar elements.

FIG. 1 is a block diagram of an overall appliance controlling system, with mobile device user interface configuration capabilities.

FIG. 2 shows a similar system in block diagram form but with high level elements of an example of the network in FIG. 1.

FIG. 3A shows an internal block diagram of an example of an appliance shown in FIG. 1.

FIG. 3B shows an internal block diagram of an example of the mobile phone shown in FIG. 1.

FIG. 4 shows an example of an XML file that is utilized to configure the user interface on the mobile phone in a system like that of FIGS. 1 and 2.

FIG. 5 shows an example of a user interface screen on a smart mobile device, for example, when the appliance being controlled is a television.

FIG. 6 shows a block diagram example of the system, specifically for controlling a vending machine.

FIG. 7 is a simplified block diagram of a computer that may be configured as a host or server, for example, to function as the server shown in FIG. 1.

FIG. 8 is a simplified functional block diagram of a personal computer, other work station or terminal that may be used for controlling appliances.

### DETAILED DESCRIPTION OF EXAMPLES

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high level, without detailed comments, in order to avoid unnecessarily obscuring aspects of the present teachings.

A need exists to provide an ad-hoc process for configuration of a mobile device, to allow a user of the mobile device to control a home appliance via the configured UI presented via the mobile device. Allowing a mobile phone to automatically recognize an appliance within a certain proximity, configure a user interface on the mobile phone, and then allow control of the appliance utilizing the user interface on the mobile device may be beneficial. This type of ad-hoc configuration and control benefits the user of the mobile phone, since the user is able to control appliances via the mobile phone with less effort at setting-up the mobile device for each new appliance. This configuration also benefits the manufacturer and/or owner of the appliance, because wear and tear of the appliance is reduced (e.g., buttons, etc. on the appliance need not be pressed since the control of the appliance may often take place via the mobile phone).

Communication between the mobile phone and the appliance can be performed over different types of communication technologies such as Bluetooth, near field communication (NFC) and long-term evolution (LTE). The configuration process can also be supported by a back-end server which acts as a middle-man between the appliances and the mobile phones.

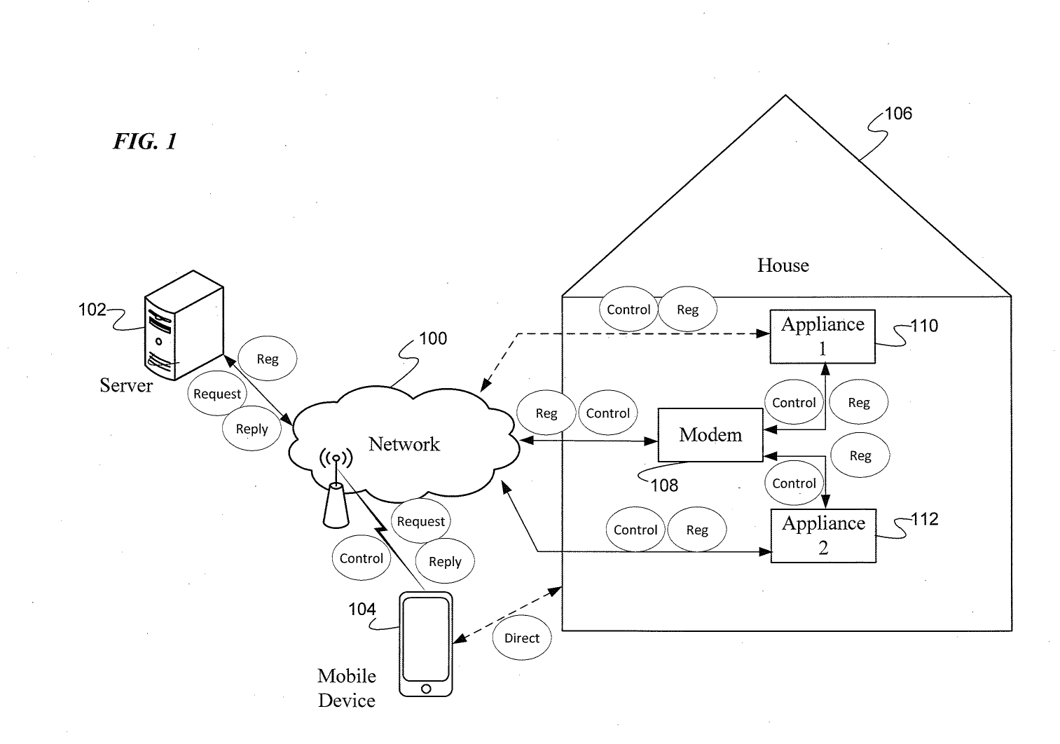

A high level view of such a system is shown in FIG. 1. At least to support some techniques for automatically configuring the user interface of a mobile device, the system includes a network connected computer programmed or otherwise configured to operate as a server 102. The server 102 may be an application server operated by a network communication service provider or carrier (e.g. as a server in an IMS network that communicates with mobile devices and appliances via the carrier's network), or the server 102 may be a computer connected to the public Internet that is operated by another enterprise offering the configuration related services (e.g. as a server operated by a vendor of a variety of appliances).

In this first example, the system also includes users' mobile devices, one of which is shown as mobile device 104 (e.g. smartphone). Mobile device 104 may also be referred to as mobile phone 104. Mobile devices, such as mobile device 104, communicate via a network 100 (e.g. including a wireless 4G LTE mobile communication network). The drawing also shows a house 106 that houses a first appliance (1) 110 and a second appliance (2) 112 (e.g. home appliances such as TVs, Ovens, Thermostats, Lights, etc.) as well as modem 108 (e.g. cable modem or fixed wireless modem). Only two appliances are shown by way of example. Also, the house 106 is shown by way of an example of a premises where the appliance(s) that the mobile device 104 controls may be located. The configuration techniques discussed herein may be applied to mobile device control of appliances in other types of locations or settings, such as facilities of various commercial, governmental or educational entities.

In general, the appliances 110, 112, mobile phone 104 and server 102 may all be wirelessly connected though LTE network 100. For example, the appliances may have internal LTE communication transceivers or connect to a type of modem 108 that provides broadband wireless data communication via LTE network. It is also possible for the mobile phone and appliances to be wirelessly connected via a non-LTE network such as a Local Area Network (LAN) using Bluetooth technology at the premises and/or via wired or wireless communications from the premises to a packet data network. Hence, although the drawing generally shows all elements communicating via a wireless network, the present teachings also encompass arrangements in which the mobile device connects via a wireless network but an appliance and/or server communicate via optical or wired media.

Mobile device 104 is shown communicating with a base station or the like of the LTE portion of network 100. If provided at the premises, mobile device 104 may also or alternatively communicate via an in-home wireless network, such as WiFi (as represented by the dotted arrow).

In one example a user of mobile phone 104 may want to control appliances 110 and 112 located within the user's home 106. As described above, appliances 110 and 112 may have a wireless connection to network 100 via LTE communication, or may communicate indirectly with network 100 via a wired/wireless connection to cable modem 108. For example, the appliances may wirelessly communicate with the modem 108 via WiFi access point and/or router (not shown) set up in the user's home. Alternatively, the appliances may be hard wired to the modem using coaxial cable or some other equivalent on-premises data communication cable. In the example, the first appliance (1) is shown with an alternative wireless communication capability (dashed line) as an optional channel for data communications. This alternative wireless communication capability may be embodied by a WiFi transceiver or a cellular transceiver within the appliance, that allow the appliance to wirelessly communicate through Network 100 (i.e. bypass Modem 108). Server 102 shown in FIG. 1 is an optional back-end server that may be utilized to support a configuration process between the mobile phone and the appliances.

In order to control the appliances, the mobile phone employs a user interface (UI) that displays controls to the user of the mobile phone. This UI provides information to the user and enables user input of selections or commands or the like for controlling an appliance as indicated by the information. The UI may support audible input/output, visible display output and key or touch input, combinations thereof, etc. In one embodiment, mobile device 104 is a smartphone of a type having a touchscreen display as at least some of the physical device components that provide the input/output capabilities for the user interface. In that example, the mobile device offers the UI to the user via the touchscreen. The UI allows the user of the mobile phone to press virtual buttons, switches, etc. that are appropriately labeled for controlling the functionality of the appliance. The UI on the touchscreen may be set up to mimic the actual control panel that is physically associated with the appliance (e.g. the UI may display remote control buttons similar to buttons on a dedicated remote control that controls the appliance, such as remote control buttons for controlling a TV type appliance). Mobile phone 104, however, may not initially know the arrangement or set-up of a UI for controlling the appliance. The techniques disclosed herein enable relatively automated configuration of the UI on the mobile device for one or more appliances. In such examples, a configuration process of the UI may involve the mobile phone 104 to retrieve the UI configuration data from the appliance 110 or 112 or from server 102. In one example, the mobile phone may detect an appliance in close proximity to the mobile phone using wireless communications such as BlueTooth. In another example, the mobile phone may already include a list of appliances and their respective locations that have been previously downloaded from a server. In either case, the mobile phone will request configuration data from either the server 102, or appliance 110/112. In one example, the request may first be made to the appliance after connecting via Bluetooth. If the appliance has the configuration data, then it is sent to the mobile phone. However, if the appliance does not have the configuration data, then the mobile phone may then have to request the configuration data from the server. This request can be made through wireless communication technology such as Bluetooth, Cellular and Near Field Communications. In any event, once the UI configuration data has been retrieved, mobile phone 104 displays the UI, responds to inputs by the user, and sends control signals and/or information to the respective appliance. The configured mobile device 104 communicates with the appliance to obtain relevant information for presentation via the UI and to send signals to the appliance, for example, to request such information and/or to control the appliance in response to user inputs.

The relevant information to generate the UI is essentially information for generating a display to the user that allows the user to interact (i.e. control) the appliance using soft buttons and other displayed information. For example, the relevant information may be embodied by XML code that describes shapes, colors, screen positions, etc., for images, icons, text, buttons, etc., that are to be displayed on the mobile phone for interacting and otherwise controlling the appliances. The relevant information may also include control function information (e.g. information for sending control signals) for each of the graphics displayed on the phone. For example, the relevant information may include information for displaying TV remote control buttons (e.g. volume buttons, channel buttons, etc.) on the mobile phone. The mobile phone will display these buttons and graphics and then send control signals to the appliance when the user of the mobile phone engages the screen (e.g. when the user pushes the volume button, the mobile phone sends a volume control signal to the TV to increase the volume).

Configuration of the UI in an ad-hoc manner where mobile phone 104 has no prior knowledge of the appliance may be beneficial. Examples of such configurations are described below.

Two alternative examples of techniques for performing configuration of a user interface (UI) on mobile device 104 to enable the user control the appliances from the device 104 will be described with respect to FIG. 1, one involving server assistance and the other involving direct communications between an appliance and a mobile device 104.

In a first example, server 102 acts as a back-end server during the configuration process to configure the mobile device UI for the control of the appliance. The server 102 may be owned and operated by the service provider or some third party. In general, the server may store information about the UIs of the appliances. This information may then be retrieved by devices (e.g. the mobile phone) that want to control the appliances.

In general, during a registration process, appliances 110 and 112 may transmit UI information (e.g. XML code that describes shapes, colors, screen positions, etc., for images, icons, buttons, etc., that are to be displayed on the mobile phone, and their respective functions for controlling the appliances via wireless control signals) to server 102 either directly through network 100 (see “Reg” messages sent from the appliances directly to network 100) or via modem 108 (see “Reg” messages sent from the appliances to network 100 via modem 108). This configuration information may be embodied in an Extensible Markup Language (XML) file. As will be described later, with respect to FIG. 4, the configuration information may include the identity of the appliance and information regarding a configuration of the UI to control the respective appliance. This information, for example, may be stored as an XML file in server 102 in the first process example (see “Reg” messages sent from network 100 to server 102). It is noted that identification information may be included in the configuration information. The identification information may identify the serial number of the appliance and the owner/operator of the appliance. For example, the identification information may indicate that the appliance is owned or associated with the user of the mobile device or with a third party.

It is noted that the uploading of the configuration information during the registration process from appliances 110 and 112 to server 102 may be automatically performed when the appliances are purchased by the user of the mobile phone and installed in their home and connected to the network facilities for data communication. Alternatively, the uploading of the configuration information may be performed once appliances 110 and 112 are powered ON and recognize/identify mobile device 104 within the home. Alternatively, the configuration information on appliances 110 and 112 may be pre-stored in server 102 by the manufacturer or distributor of the appliances. In either case, server 102 stores this configuration information of the appliances and makes this information accessible to devices such as mobile phone 104.

In addition to registration by the appliance, the mobile device number (MDN) of the mobile phone may also be uploaded to the server for storage. This allows the server to associate the MDN with purchased appliances for configuring the UI on the mobile device. This also allows the server to restrict mobile devices that do not have their MDN associated with the purchased appliance. Restricting access of the mobile phones to the appliances may be performed by a list of MDNs or other ID numbers of the mobile device that are stored on the server or stored on the appliance itself. The server or appliance will check the list when a request for the UI is received. If ID number sent from the mobile device during the request does not match a stored ID, then the server or the appliance will not send the UI information to the mobile device. In one example, a rejection message may be sent by the server or the appliance to the mobile device when the IDs do not match. The rejection message will be displayed to the user of the mobile device.

In addition to outright restriction of a mobile device described above, partial restrictions may also be included. For example, a MDN may be allowed to control appliances, but may be restricted to operate certain appliances, and at certain times of the year, month, week, day, etc. In one example, the mobile device may be operated by a child. The parents may restrict the child's control over an appliance such as a TV (e.g. restricted channels, times of day to watch TV, etc.) by uploading instructions to the server to restrict use for the particular MDN. In another example, the mobile device may be operated by a person in an arcade. The arcade may restrict the persons to controlling particular games and/or to operating the games at particular times based on payment to the arcade owner.

Although the following examples describe control of home appliances, it should be noted that the appliances may be any mechanical, electrical or electromechanical device located anywhere such as an office, restaurant and other residential and commercial enterprises. In addition to the traditional elements and functions of the appliance, the appliances here also have controllers and network interfaces to enable the appliances to communicate via data network(s) for various purposes, e.g. for monitoring or control, etc.

This configuration information (e.g. code or data describing the visual display of a UI and responses to particular user inputs via the UI, for controlling the respective appliance) may then be transmitted from server 102 to mobile phone 104. An example will be shown and described later in which the UI presents a virtual TV remote control on the display, and mobile device 104 sends corresponding TV control commands in response to user touches of the virtual control buttons on the touchscreen of mobile device 104. The UI appear different for different types of appliances, and set-up of such different appliance related UIs on the mobile device entails obtaining corresponding different configuration information.

In the present automated UI configuration techniques, the information (see “Reply” messages from server 102 to mobile device 104 via network 100) for configuring such a user interface for controlling the particular appliance(s) may be sent to mobile phone 104 in response to the mobile phone requesting this configuration information (see “Request” messages from the mobile phone to the server via network 100). This allows mobile phone 104 to set up a user interface and display the user interface on the mobile phone so that the user of mobile phone 104 may control appliances 110 and 112 (see “Control” messages sent from mobile phone 104 to the appliances via network 100). The control messages may be sent directly from the network to the appliances, or may be routed through modem 108.

For example, prior to configuration, the mobile phone may display the identity of the appliances. The user may then select the appliance to control. In response to this selection, the mobile phone may then send the “Request” message and receive the “Reply” message. The “Reply” message may include the UI information which is then displayed to the user (i.e., the controls of the appliance are displayed on the phone). When the user interacts with the controls on the phone, the phone then sends the “Control” messages to the appliances. The appliances control themselves in response to these “Control” signals. The appliances may also send information back to the mobile phone in response to the “Control” messages. For example, assuming the appliance is a television, and the user sends a “Control” message to change the channel, the TV may change the channel and report back to the mobile phone that the channel has been successfully changed. The mobile phone displays the new channel as being the current displayed channel. In addition to displaying the channel, the mobile phone may also include haptic feedback (e.g. vibrations, etc.) and sound feedback (e.g. beeps, etc.) to interact with the user of the mobile phone when controls are sent to the appliance, and when the display on the mobile device has changed during operation of the appliance.

Now, assuming for example, appliance 110 is a thermostat and appliance 112 is a television, the configured mobile phone may have the capability to display two different UIs. In a first UI, temperature controls for controlling appliance 110 may be displayed on the phone. In a second UI channel buttons and volume buttons for controlling television 112 may be displayed on the phone. These controls may be soft buttons/switches, etc. that look similar to what a user might find on a standard thermostat or television remote control. The user will be able to toggle between the two different UIs to control the appropriate appliance. The user phone, for example, may display an icon for each appliance. When the user selects the TV icon, then the TV UI is displayed. When the user selects the thermostat icon, then the thermostat UI is displayed. This allows the user to quickly toggle between controlling numerous appliances.

Although the first example was described with respect to server 102 being a middle-man in the process, server 102 in some embodiments may not be necessary for the operation of the system. Specifically, mobile phone 104 may communicate directly with appliances 110 and 112 (see “Direct” messages communicated between the mobile phone and the appliances). For example, upon being plugged in, appliances 110 and 112 may transmit configuration information (e.g., the XML file containing the display information for the UI that controls the appliance) directly to mobile phone 104. This allows mobile phone 104 to similarly set up and display the two user interfaces for controlling appliances 110 and 112. This communication from appliances 110 and 112 may be performed utilizing LTE communication, Bluetooth communication, NFC communication, etc.

For example, when the user approaches the TV for the first time with the mobile phone, the TV and mobile phone begin to communicate via Bluetooth. The TV may identify itself. If the user desires to communicate with the appliance, communication is initiated. The mobile phone and TV may both exchange identification information. Once the devices have identified and authorized each other for communication, the TV may then send UI display information to the mobile phone (i.e. the “Reg” message which includes the UI information is sent directly to the mobile phone rather than being sent to the server). Upon receiving the UI information, the mobile phone displays the UI (e.g. channel and volume buttons) which allows the user to control the TV. It should also be noted that the mobile phone and appliances may be able to communicate through network 100 if the appliances have LTE capabilities. In any case, the communication may still not require server 102 since the mobile phone and appliances are capable of communicating through the network, or directly to each other. In another example, the mobile device and appliance may perform communication and control without the server when the server is offline. This may be a default scenario. For example, the mobile device and appliance may prefer the server acting as a middle man to UI configuration. However, if the server is offline, then configuration process may default to being performed directly between the mobile device and the appliance without the aid of the server.

For security purposes, since appliances 110 and 112 are owned by the user of mobile phone 104, then the configuration of the UI and subsequent control of appliances 110 and 112 may be restricted by mobile phone 104. The configuration of the UI and subsequent control of the appliances may also be extended to other mobile phones of permitted users, e.g. to other devices on the user's mobile account (e.g., husband, wife, child may be able to configure the UI and control the appliances since they are on the same mobile plan). These restrictions may be implemented by setting up a password that needs to be entered in order to retrieve the user interface from the server or appliance (i.e. a password may need to be entered by the user of the mobile phone so that the server or appliance sends the UI to the mobile phone during the configuration process). For example, the mobile phone may detect the appliance and provide notification to the user, including a display. The user may select the appliance for UI configuration from the display. In the server based configuration technique, in response to the selection, the mobile phone may send a request to the server through the network. The server may respond with a request for the password. If the user knows the password, it is entered in the mobile phone and then sent to the server. The server then verifies the password and sends the UI information to the mobile phone allowing the mobile phone to configure the UI to control the appliance. Other authentication mechanisms may be used instead of or in addition to a password, e.g. voice print or finger print input. It should also be noted that in examples where the server is not involved (i.e. direct communication between the phone and the appliances), the appliance may request the password from the mobile phone, and verify if the password is correct (i.e. the appliance may perform the authorization for control). Alternatively, a password may not be needed. For example, the user of the mobile phone or the owner of the appliance may send a message to the server that indicates restrictions on the use of the mobile phone and/or the use of the appliance. These restriction will be associated with the ID of the mobile phone and the ID of the appliance respectively. These restrictions would be implemented by the server without the need for a password.

Rather than, or in addition to, restricting UI access due to mobile plan requirements, the restrictions can be for various reasons. For example, restrictions may be location based. The server may not send the UI to the mobile phone until the mobile phone can verify a predetermined location where control of the appliance is authorized by the appliance owner. In one example, the appliance owner may send a restriction message to the server identifying locations where control of the appliance is allowed and/or restricted. Upon receiving a request of the appliance UI from a mobile device, the server will compare the location of the mobile device to the identified locations in the restriction message. If the mobile device is located in an allowed area, then the UI is sent to the mobile device. If the mobile device is located in a restricted area, then the UI is not sent to the mobile device.

In the simplest examples, the configuration techniques outlined above provided information to mobile phone 104 to configure mobile device 104 to provide appliance adapted UI input and output capabilities for one or more respective appliances 110 or 112. The configuration procedures, however, may be enhanced to help the user to set-up other aspects of the control interface for one or more of the appliances. For example, whether or not user authentication is needed in order for mobile device 104 to obtain the UI configuration, the user may desire to restrict access to the configured UI and related appliance control functions (for operations after configuration is complete). For such purposes, either of the UI configuration techniques may be adapted to set the configuration of the UI so that the UI and the subsequent control of appliances 110 and 112 is restricted on mobile phone 104, e.g. to require user authentication to access the configured UI on the mobile device 104. In a simple example, a restriction may be implemented by setting up a password during the UI configuration procedure, e.g. as part of the interaction with the server in the server assisted first example procedure. Thereafter, the password may need to be entered in order to access the UI for the corresponding appliance. Authentication may involve verification of a user input PIN (personal identification number) or password, or of a biometric input such as a fingerprint, voiceprint or image; and the configuration procedure will provide assistance to the user in setting up the desired authentication technique.

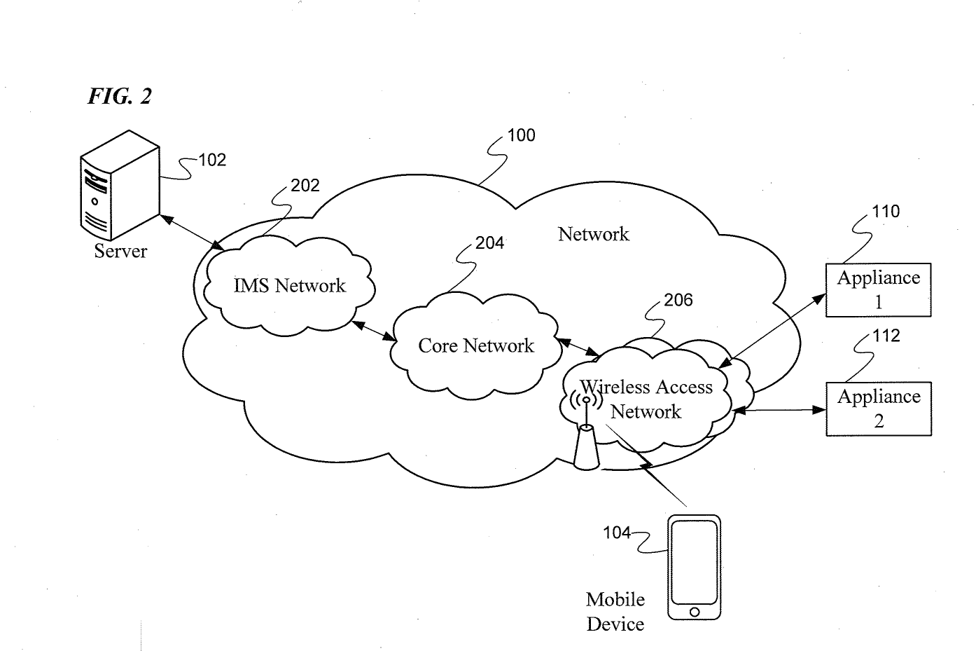

The descriptions above with respect to communication through network 100 have been described on a high level. It is noted that network 100 may be an LTE network that includes multiple networks interconnected with each other. A description of details of network 100 are described below with respect to FIG. 2.

FIG. 2 shows a more detailed view of network 100 in FIG. 1, and signaling flow through the networks for appliance registration with the server and mobile device UI configuration and control of the appliances. In general, the mobile device and appliances communicate with an access network. If wireless, these communications may be with the wireless access network 206. For cable or fiber communications, the appliances may use the modem or the like and communicate with an access network based on a different (e.g. non-wireless) access technology. In the example of a network architecture, the access network(s) provide packet switched logical “connections” for data communications with a core network 204 that connects to other networks such as IMS network 202 to provide signaling to establish voice and data communications. The wireless access network for example, may be a cellular or a Wi-Fi network, and the core network may be packet data network (PDN) or an evolved packet core (EPC). The wireless access network may be accessed via base stations now sometimes referred to as an evolved node B (eNodeB or eNB). The core network may provide services such as a home subscriber server and a packet data gateway (not shown). Other network elements (not shown) may further facilitate session setup and provision of multimedia services for the mobile device and appliances.

The communications in a communication signaling protocol from the wireless access network and core network are passed to the IMS network through packet data network gateway (PGW) devices (not shown). The PGWs act as interfaces between, for example, the core network and the IMS network. Servers providing application layer services of the network operator or carrier may reside in the IMS. The server 102, for example, may be on a computer platform in the IMS if the configuration service is offered by the network operator.

It is noted that although FIG. 2 shows these specific devices within the specific networks, that in different examples, different hardware devices may or may not be included within each network. It is also understood that although the user devices are shown as mobile devices, these may include any devices capable of network communications. For example, they may include a corded or cordless telephone, cellphone, Smart phone, laptop computer, tablet computer, desk top computer or another type of computing or communications device. Each of the EUDs may also have separate identifying (e.g., telephone) numbers and is able to connect to one or more networks which may have different access technologies.

Networks 202, 204 and 206 of network 100 may include any type of network or combination of networks such as LAN, MAN, WAN, WWAN, etc. Each of networks may be capable of providing a variety of communication network services, such as registration services, authentication services, authorization services, call session control services and other types of communication services.

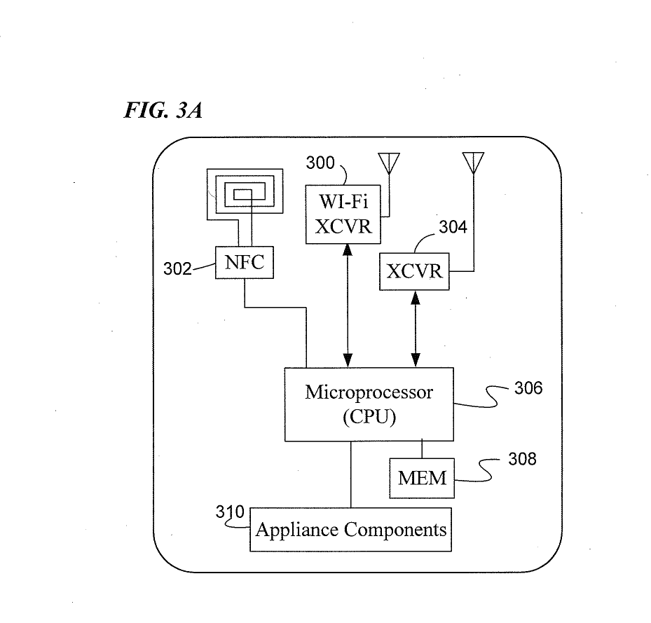

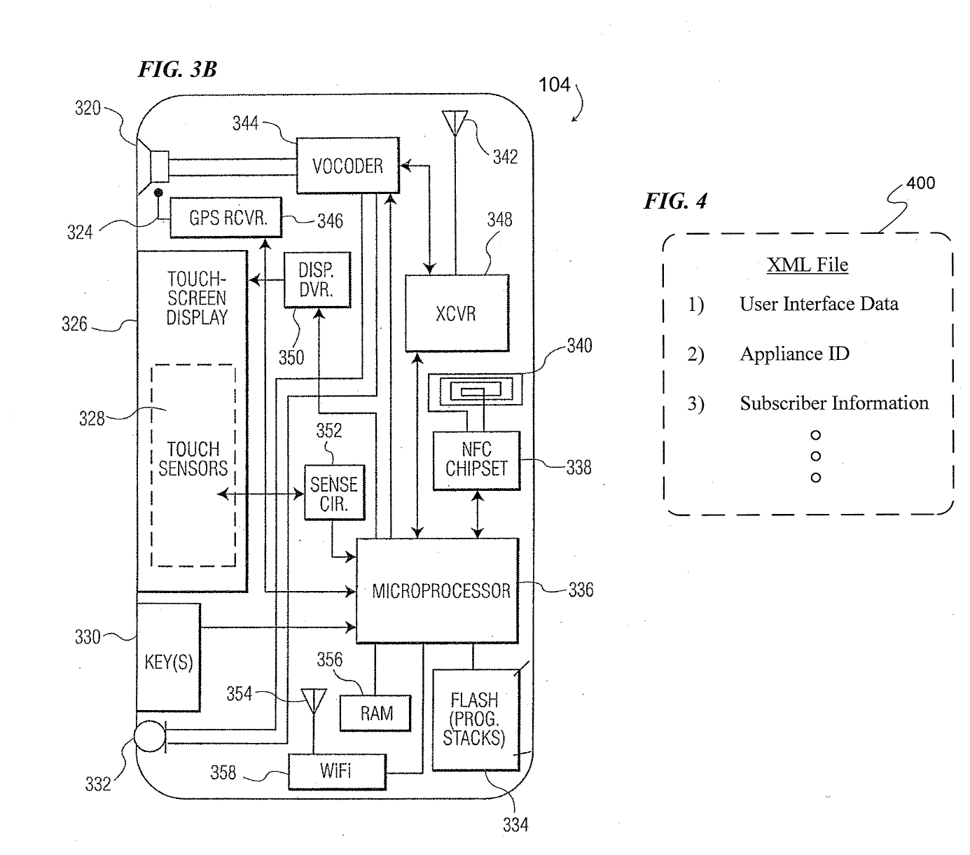

Shown in FIG. 3A is a block diagram of an example of appliance 110 of FIG. 1. Appliance 112 may be implemented in a similar or different manner. For its appliance functions, the appliance includes components shown generally as 310. Operations of the appliance are controlled by a central processing unit 306 configured by programming stored in memory 308. A microprocessor for example includes one or more integrated circuit (IC) incorporating the electronic elements to perform the functions of a central processing unit (CPU). The CPU functions 306, for example, may be based on any known or available microprocessor architecture, such as a Reduced Instruction Set Computing (RISC) using an ARM architecture, as commonly used today in mobile devices and other portable electronic devices. Of course, other processor circuitry may be used.

As already described, appliance 110 may be able to communicate in various manners with both the server and the mobile phone. Specifically, appliance 110 may include one or more of a WiFi transceiver 300 which supports communication with the mobile device, an NFC transceiver 302 which also supports communication with the mobile device, and a mobile wireless XCVR transceiver 304 for LTE communications through the LTE network. Other communication interfaces may be provided in addition to or instead of any of those shown. The three transceivers as well as memory 308 for storing the software for controlling the various appliance components 310 (e.g. motors and other mechanical mechanisms for dispensing goods from the vending machine) may be controlled by a central processing unit (CPU) such as microprocessor 306. These three transceivers may also support direct wireless and network based communication between the mobile phone and other devices that are not shown (i.e. other mobile devices and other appliances).

Thus, assuming that appliance 110 is a vending machine, CPU 306 may detect that NFC transceiver 302 has received the signal from a mobile phone. CPU 306 may then direct WiFi transceivers 300 or 304 to communicate with the mobile phone and/or the server in order to allow the mobile phone to identify the appliance and configure the user interface on the mobile device for controlling the appliance. Once the user interface is configured, mobile phone 104 may then communicate back with CPU 306 via any of the three transceivers. CPU 306 may then receive the control signals from the mobile phone and then control the appliance components 310 accordingly (e.g., dispense a particular product in the vending machine).

FIG. 3B shows an example of internal components of mobile device 100. It should be appreciated that although the examples described throughout have been described with respect to LTE and BlueTooth communications, the disclosed subject matter may also be implemented using other communication technology standards such as NFC communication capability, mobile communication capability and other radio frequency (RF) communications.

In the example of FIG. 3B, the mobile device 322 is in the form of a smart phone type mobile handset including a touch screen display. Examples of touch screen type mobile devices that may be used to implement mobile device 322 may include, but are not limited to, a smart phone, personal digital assistant (PDA), tablet computer or other portable device. However, the structure and operation of the touch screen type mobile device 11 is provided by way of example; and the subject technology as described herein is not intended to be limited thereto. For purposes of this discussion, FIG. 3B provides a block diagram illustration of the exemplary mobile device 322 having a touch screen display for displaying content and receiving user input as or as part of the user interface.

Hence, in the example shown in FIG. 3B, mobile device 322 includes a microphone 332 for audio signal input and a speaker 320 for audio signal output. The microphone 332 and speaker 324 are communicatively coupled to a voice or audio encoder/decoder (vocoder) 344.

Also, as shown in FIG. 3B, the mobile device 322 includes at least one digital transceiver (XCVR) 348, for digital wireless communications via a wide area wireless mobile communication network, although the mobile device 322 may include additional digital or analog transceivers (not shown).

Examples of such transceivers include, but are not limited to transceivers configured to operate in accordance with Code Division Multiple Access (CDMA) and 3rd Generation Partnership Project (3GPP) network technologies including, for example and without limitation, 3GPP type 2 (or 3GPP2) and 3GPP Long Term Evolution (LTE), at times referred to as “4G.”

Transceiver 348 connects through radio frequency (RF) send-and-receive amplifiers (not separately shown) to an antenna 342. Transceiver 348 may also support various types of mobile messaging services, such as short message service (SMS), enhanced messaging service (EMS) and/or multimedia messaging service (MMS).

Many modern mobile devices also support wireless local area network communications over WiFi, instead of or in addition to data communications using the wide area mobile communication network. Hence, in the example of FIG. 3B, for packet data communications, the exemplary device 322 also includes a WiFi transceiver 358 and associated antenna 354. It is noted, that the highlighters and central processor may also include these types of transceivers for providing wireless communication capabilities.

Mobile device 322 further includes a microprocessor (or “processor”) 336, which serves as a programmable controller circuit or CPU for the mobile device 322 by configuring mobile device 322 to perform various operations, for example, in accordance with instructions or programming executable by processor 336. A flash memory 334 is also used to store, for example, programming or instructions for execution by the processor 336. Mobile device 322 may also include a non-volatile random access memory (RAM) 356 for a working data processing memory. The software stored in the memory devices, for example, may include the software (data and/or code) of the UI received from the server, and instructions for controlling the appliances through the network (i.e. commands for controlling the appliance in a certain manner). The CPU may access this software and display the UI on the touch screen display of the mobile phone.

For discussion purposes, in the smart phone example shown in FIG. 3B, the user interface elements of mobile device 322 include a touch screen display 326 (also referred to herein as “touch screen 326” or “display 326”). For output purposes, the touch screen 326 will include a display screen, such as a liquid crystal display (LCD) or the like. For input purposes, touch screen display 326 includes a plurality of touch sensors 328. Other interface elements may include a keypad including one or more keys 330.

In some implementations, the microphone 332 and speaker 320 may be used as additional user interface elements, for audio input and output, including with respect to some functions related to the transaction processing and communication, as described herein.

Processor 336 controls visible display output on the LCD or other display element of the touch screen display 326 via a display driver 350, to present the various visible outputs such as the UI for controlling the appliance to the device user. For example, some of the XML data received from the server may cause the processor 336 to operate the driver 350 to cause screen 326 to display visible the buttons, switches, wording, etc. of the UI for controlling the appliance.

As shown in FIG. 3B, mobile device 322 also includes a sense circuit 352 coupled to touch sensors 328 for detecting the occurrence and relative location/position of each touch with respect to a content display area of touch screen display 326.

There are also a variety of ways that a mobile device may be configured to obtain information as to current location of the device. In our example, the mobile device 322 includes a global positioning satellite (GPS) receiver 346 and associated antenna 324. The mobile device 322 may also have NFC communication capability through NFC chipset 338 and NFC antenna 340.

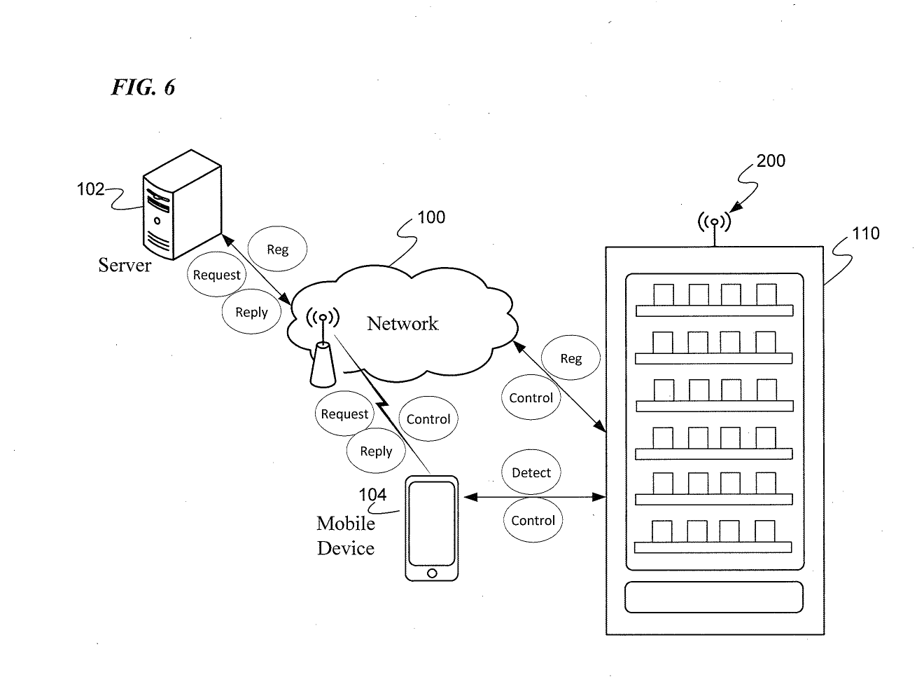

In one example, where GPS signals are available, the mobile device may utilize its GPS receiver to determine its location. This location information along with IDs of the mobile phone and/or appliance can then be transmitted to the appliance and/or the server to retrieve the UI information for controlling the appliance. If GPS is not available, a simple ping between a beacon (see FIG. 6) on the appliance and the mobile device could be utilized to determine the mobile device location relative to the appliance. This direct communication and ping between the mobile device and appliance can be accomplished with BlueTooth or some other equivalent transmission protocol.

Since the mobile phone shown in FIG. 3B may include a GPS receiver, the configuration process may be triggered by the known location of the mobile device. For example, assume that the appliance does not have a beacon, but mobile phone 104 has a GPS receiver. In this example, the mobile phone may realize that it is within proximity to a known appliance (i.e. an appliance with a known location stored on the server) based on its computed GPS position. In this example, the mobile phone may retrieve the configuration information either directly from the appliance or from server 102 as described in the previous examples. For example, the server may not only store the UI information of the appliance, but also the location information of the appliance. The location information of appliances may be retrieved by the mobile phone from the server either during the configuration process or prior to the configuration process (i.e. the phone can locate the appliance it wants to control prior to configuring the UI). The mobile phone may then monitor its own position relative to the appliances. Once the phone determines that it is within a certain proximity to an appliance, then the phone may request the UI from the server, receive the UI from the server, configure and display the UI and control the appliance. If the mobile phone is located within a certain proximity to multiple appliances, the mobile phone may request the UI for each of the appliances from the server. Each of the UIs may be sent to the mobile phone and listed on the mobile phone such that the user can select the appliance they wish to control. In one example, the list of appliances may be ordered from closest proximity to furthest proximity to the mobile phone.

As described with respect to FIGS. 1 and 2, the configuration information may include various pieces of information pertaining to the appliance. In one example, shown in FIG. 4, the configuration information may be embodied by XML file 400. This XML file 400 among other things may include user interface data which is utilized to configure the user interface on the mobile phone, appliance identification information which identifies the appliance to both the mobile phone and the server, and other subscriber information. Subscriber information may be information related to the owner of the appliance and whether they are subscribed to perform wireless control of the appliance via a LTE network or simply through WiFi communications.

For example, assuming that appliances 110 and 112 as shown in FIG. 1 have LTE capabilities, they may be identified by two unique IDs. The user interface data with respect to the thermostat and television may show the mobile phone where and how to place the virtual buttons on the screen for control of the respectively identified two appliances. The subscriber information may be related to the mobile phone user's subscriber information to its mobile carrier (e.g., information showing that the mobile phone, appliance 1 and appliance 2 are all subscribed to the same mobile data plan).

As described with respect to FIG. 1, appliance 112 may be a television set in a user's home. The mobile phone 104 may retrieve the XML file directly from television 112 or from back-end server 102 during the configuration process. Since the XML file may include the identity of the mobile device, UI information, subscriber information, as well as other relevant information, the mobile phone 104 may confirm the identity of television appliance 112, confirm that the subscriber information in the XML file is up to date, and then extract the user interface data.

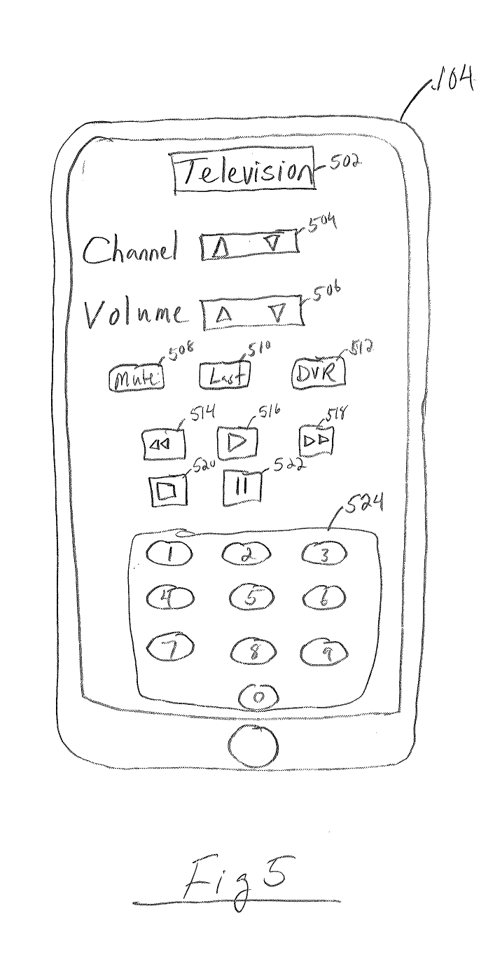

User interface data to control the television may include virtual button placement for up and down channels 504, up and down volume 506, mute button 508, last button 510, DVR button 512, reverse button 514, play button 516, fast forward button 518, stop button 520, pause button 522 and numerical keypad buttons 524. These buttons, as shown in FIG. 5, will be displayed on the user's mobile phone much in the same way that they are displayed on a typical remote control utilized to control a television. Once the user presses the buttons on the mobile phone, control messages are sent from the mobile phone to the appliance. The appliance controls its internal mechanisms based on the control message (e.g., soda machine dispenses the Soda A if the user of the mobile phone selects Soda A on the UI).

It is noted that the mobile phone may be associated with a credit/debit account. In the example of the soda machine described above, when the user selects a soda to be dispensed, the credit/debit account information of the user is sent from the mobile device to the appliance for verification. The appliance may then send this account information to a backend server (not shown) where the appropriate amount of money corresponding to the soda is then added/deducted from the user's credit/debit account. Alternatively, the mobile phone may send the account information directly to the backend server for verification. Upon verification, the backend server will instruct the soda machine to dispense the selected soda.

In one example, when a user presses a button on the UI displayed on the touchscreen, the mobile phone identifies the selected virtual control button and sends a corresponding control command through the applicable media or network(s) to the appliance associated with the currently presented UI. The control may be sent directly to the appliance via BlueTooth, or may be sent through network 100 assuming the appliance can communicate through the network. The appliance will receive the control command and control the mechanical and electrical mechanisms accordingly. For example, if the appliance is a TV, then the appliance will adjust its channels and volume when control signals for these features are received from the mobile phone. If the appliance is a vending machine, then the appliance dispenses products that have been selected and paid for by the user. In either case, the appliance will respond to the control signals generated by the mobile device in response to the user's interaction with the UI (i.e. based on the displayed buttons pressed by the user). Prior to sending the command to the vending machine, the mobile phone may also request additional confirmation from the user to avoid accidental selection of a product. For example, the mobile phone may require that the user push a confirmation button to confirm an order for a particular product before the command is actually sent to the appliance (i.e. the user will select the product and then confirm the order).

Since these buttons are virtual, this also allows the appliance, the manufacturer of the appliance and the mobile phone user to make various configuration updates for specific button placement, button addition and button deletion. For example, the owner of the appliance may send an updated XML file to the server which includes updated UI configuration data (e.g. new button placement, new options, etc.). The server will delete the old XML file and store the new XML file in its place. The updated UI configuration data will then be sent as a software update (e.g. periodically, or upon the user attempting to operate the appliance) to mobile devices that have the old UI for the appliance. Once the user of the mobile phone confirms the update, the new UI is configured on the mobile device. This essentially reduces overall cost of producing the television since physical remote controls will no longer be needed. Every user will be able to use their mobile phone to control their television in the various manners described above.

The examples described with respect to FIG. 1 above, are specific examples where the user of mobile phone 104 actually owns or is associated (e.g. renter of home, employee in office, etc.) with the owner of the appliances 110 and 112. However, there could be another example where the owner of the mobile phone 104 is different from the owner of appliances 110 and 112. This example may be realized when appliances 110 and 112 are appliances not in the user's home, but rather appliances in a department store or work environment.

For example, appliance 110 may be a vending machine in a public area as shown in FIG. 6. Prior to arriving in the public area, mobile phone 104 may have no knowledge that vending machine 110 exists, or how to control it. However, upon entering the public area, and approaching vending machine 110, the configuration process may begin.

Specifically, in one example, vending machine 110 may have a beacon transmitter 200 (e.g. BlueTooth Beacon) which may ping mobile phone 104 to determine that mobile phone 104 is within close proximity to the vending machine. Upon determining that mobile phone 104 is within proximity to the vending machine, a configuration process for the user interface may occur.

In a first example, vending machine 110 (i.e. the appliance) may send the configuration information (e.g. identification information, UI information, restriction information, etc.) to server 102 via network 100. The mobile phone and/or the vending machine may detect via a beacon or other communication technology that the mobile device is within close proximity to the vending machine. A request (including the identity of the vending machine) may then be sent by the mobile device to the server requesting the UI information for controlling the vending machine. Server 102 may then relay the UI configuration information to mobile phone 104 via network 100. This allows mobile phone 104 to set up and display the user interface for controlling the vending machine 110. In a second example, the vending machine 110, upon detecting that mobile phone 104 is in a certain proximity to the vending machine, may send the configuration information directly to mobile phone 104. In this example, mobile phone 104 displays the user interface (e.g. buttons of items in the machine) allowing the user to control vending machine 110. In yet another example, the user interface information may already be pre-stored on server 102. Upon detecting the presence of mobile phone 104, vending machine 110 may send its identification information to mobile phone 104 and then mobile phone 104 may utilize this identification information to retrieve the user interface configuration information from server 102 via network 100.

In yet another example, mobile phone 104 may have NFC capabilities. With this configuration, the user of mobile phone 104 may place mobile phone 104 in close proximity to the NFC communicator located within vending machine 100. This action may then initiate the configuration process as previously described above (i.e., the NFC is essentially the trigger for starting the configuration of user interface on mobile phone 104).

Although it is described above that the vending machine is detecting the proximity of the mobile phone to initiate the configuration, other methods may be employed. The mobile phone may detect its proximity to the vending machine using a pre-stored map and GPS. The mobile phone may also be triggered manually by the user of the mobile phone to start the configuration process. The server may also monitor the locations of the mobile phone, vending machine and their relative proximity to each other. These locations can be used to determine when configuration of the UI should be performed, and when control of the appliance is appropriate.

Although there are many ways in which the configuration may be triggered and in which the mobile phone 104 may receive the configuration information, it is noted that this configuration can be performed in an automatic and ad-hoc manner. Specifically, mobile phone 104 does not need to know any information about the vending machine 110, for the user to configure their mobile device to control the machine, prior to coming in proximity to vending machine 110. The configuration of the user interface on mobile phone 104 for controlling the vending machine is essentially automatically transmitted to the mobile phone and then configured on mobile phone 104.

Such a process is beneficial to mobile phone 104 since mobile phone users can adapt their mobile device to control various appliances just about anytime and/or anywhere. However, such a system will also be beneficial to the owner of appliance 110 since, once configured, the mobile phone users will not have to physically interact with appliance 110 to actually control the appliance. For example, users may not have to push buttons on the vending machine or insert money; and therefore the buttons, mechanical devices and displays on the vending machine may not wear out as quickly as they normally would.

For example, the user can approach the vending machine which will then start the configuration process. Once the mobile phone receives the information for the user interface during the configuration process, the UI is displayed on the mobile phone allowing the user of the mobile phone to select an item from the vending machine. The user can also use their credit/debit card information stored in the phone to pay for the item. For example, the credit/debit card info can be transmitted through the network either directly from the phone or via the machine. The server 101, or some other third party server (not shown), for example, verifies this information and sends an authorization command to the machine. The machine then dispenses the item to the user. In this example, buttons on the machine and coin/bill acceptors may not be needed. This may reduce the overall cost of building the machine and maintaining the machine.

Although it is described above that a mobile phone will control the appliances, it should be noted that any device mobile or otherwise can use the techniques described above to configure the user interface and allow ad-hoc control over the appliances. For example, a general purpose computer (e.g. desktop, laptop, etc.) may also be used to control appliances. A description of these computers are described below.

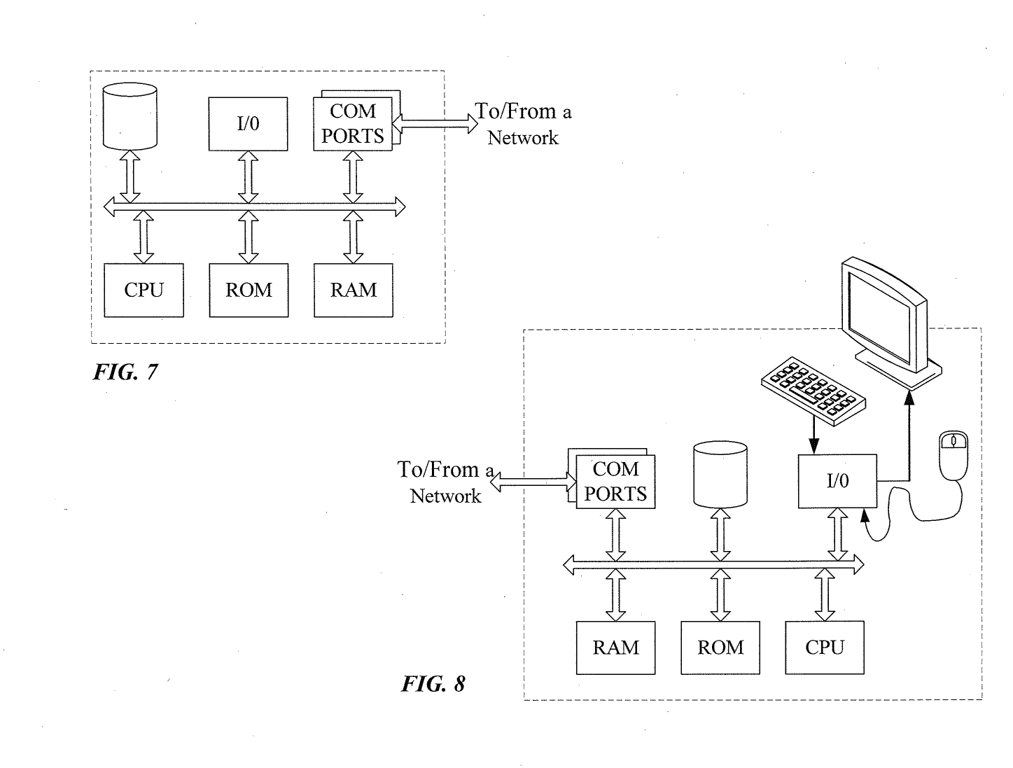

As shown by the discussion above, at least some examples of the UI configuration and possibly some operations of subsequent remote control may be implemented on devices configured as servers or other computers. FIGS. 7 and 8 provide functional block diagram illustrations of general purpose computer hardware platforms that may be used to implement the various devices in FIG. 1. FIG. 7, for example, illustrates a network or host computer platform, as may typically be used to implement a server such as server 102 in FIG. 1. FIG. 8 depicts a personal computer with user interface elements, as may be used to implement a personal computer or other type of work station or mobile terminal device for controlling the appliances in FIG. 1, although the computer of FIG. 8 may also act as a server if appropriately programmed. It is believed that the general structure and general operation of such equipment as shown in FIGS. 7 and 8 should be self-explanatory from the high-level illustrations.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 8). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature.

Hence, aspects of the methods of providing the configuration of the UI on the mobile phone and control of the appliances outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the service provider into the computer platforms of the highlighters and the in store processing system. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the mobile devices, highlighters, servers, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It should be noted that the configuration information for configuring the UI on the mobile phone may be similar for all mobile phones or may be different. For example, a standard XML file should be readable by all mobile phone platforms and other controlling devices such as home PCs, tablets, etc. Some devices, however, may require special configuration information. For these devices, the server might store special configuration files or store a general file that can be readily converted to appropriate formats for different types of mobile devices. The server would have to then identify the device and its platform to determine the appropriate UI information for transmission.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A server comprising:
a memory storing instructions; and
a processor to execute the instructions to:
receive registration information from an appliance,
the appliance being different than the server,
the registration information including identification information of the appliance and information for configuring a user interface, of a mobile device, to control the appliance;
receive, over a cellular network, a request from the mobile device,
the mobile device being different than the server and the appliance,
the request including the identification information of the appliance; and
transmit, over the cellular network and to the mobile device, configuration information to configure the mobile device to display the user interface,
the mobile device wirelessly controlling the appliance via the user interface on the mobile device.

2. The server of claim 1, wherein the server is associated with an IP Multimedia Core Network Subsystem (IMS) network, and
wherein the mobile device, using the user interface, is to transmit one or more commands, via the cellular network, to the appliance to control the appliance.

3. The server of claim 1, wherein the processor is further to store registration information for a plurality of appliances,
one or more appliances, of the plurality of appliances, being owned by a user of the mobile device, and
one or more other appliances, of the plurality of appliances, being owned by third parties independent from the user of the mobile device.

4. The server of claim 1, wherein the processor is further to:
store registration information in an Extensible Markup Language (XML) file, and
transmit the XML file to the appliance,
wherein the XML file, is retrieved by the mobile device, from the appliance.

5. The server of claim 1, wherein the processor is further to:
transmit, to the mobile device, a request for a password; and
receive, from the mobile device, the password,
wherein, when transmitting the configuration information to the mobile device, the processor is to transmit the configuration information based on the password.

6. The server of claim 1, wherein the processor is further to:
authenticate the mobile device based on receiving the request from the mobile device,
the mobile device being authenticated based on the identification information of the appliance and identification information of the mobile device.

7. The server of claim 1, wherein the registration information includes subscriber information relating to whether the appliance is subscribed to a service provided by the server.

8. A mobile device, comprising:
a memory storing instructions; and
a processor to execute the instructions to:
receive identification information of an appliance,
the identification information identifying the appliance and being received from the appliance;
transmit, over a cellular network, a request to a network server,
the request including the identification information received from the appliance and a request for configuration information for configuring a user interface to control the appliance,
the network server being different than the mobile device;
receive, over the cellular network, the configuration information from the network server;
display the user interface on the mobile device for controlling the appliance, based on the configuration information received from the network server; and
send a control command to the appliance based on a user, of the mobile device, interacting with the displayed user interface.

9. The mobile device of claim 8, wherein, when receiving the configuration information, the processor is further to:
receive, via a long-term evolution (LTE) transceiver of the mobile device, the configuration information over an LTE network, and
wherein, when sending the control command, the processor is to send the control command, via the LTE transceiver of the mobile device, over the LTE network.

10. The mobile device of claim 8, wherein, when receiving the identification information, the processor is to:
receive, via a Bluetooth transceiver of the mobile device, the identification information, and
wherein, when sending the command, the mobile device is to:
send the control command to the appliance via the Bluetooth transceiver.

11. The mobile device of claim 8, wherein, when receiving the configuration information, the processor is to receive the configuration information as an Extensible Markup Language (XML) file from the network server.

12. The mobile device of claim 8, wherein, when sending the command, the processor is to send the control command to the appliance over the cellular network.

13. The mobile device of claim 8, wherein, when receiving the identification information of the appliance, the processor is to receive, via a Bluetooth transceiver of the mobile device, the identification information of the appliance,
wherein the processor is further to send identification information of the mobile device to the appliance via Bluetooth using the Bluetooth transceiver, and
wherein the mobile device and the appliance are authorized to communicate with each other based on the identification information of the appliance and the identification information of the mobile device.

14. The mobile device of claim 8, wherein the processor is to:
determine, using a global positioning system (GPS) receiver, a location of the mobile device, and
wherein, when transmitting the request, the processor is transmit the request based on the location of the mobile device to and a location of the appliance.

15-20. (canceled)

21. A non-transitory computer-readable medium for storing instructions, the instructions comprising:
one or more instructions that, when executed by one or more processors of a mobile device, cause the one or more processors to:
receive identification information of an appliance,
the identification information being received from the appliance;
transmit, over a cellular network, a request to a network server,
the request including the identification information received from the appliance and a request for configuration information for configuring a user interface to control the appliance,
the network server being different than the mobile device;
receive, over the cellular network, the configuration information from the network server;
display, based on the configuration information, the user interface on the mobile device for controlling the appliance; and
send a control command to the appliance based on a user, of the mobile device, interacting with the user interface.

22. The computer-readable medium of claim 21, wherein the one or more instructions to receive the configuration information include:
one or more instructions to receive, via a long-term evolution (LTE) transceiver of the mobile device, the configuration information over an LTE network, and wherein the one or more instructions to send the control command include:
one or more instructions to send the control command, via the LTE transceiver of the mobile device, over the LTE network.

23. The computer-readable medium of claim 21, wherein the one or more instructions to receive the configuration information include:
one or more instructions to receive, via a Bluetooth transceiver of the mobile device, the identification information, and
wherein the one or more instructions to send the control command include:
one or more instructions to send the control command to the appliance via the Bluetooth transceiver.

24. The computer-readable medium of claim 21, wherein the one or more instructions to send the control command include:
one or more instructions to send the control command over the cellular network to the appliance.

25. The computer-readable medium of claim 21, wherein the one or more instructions to transmit the request include one or more instructions to transmit the request based on a location of the mobile device and a location of the appliance.

26. The computer-readable medium of claim 21, wherein the configuration information is included in an Extensible Markup Language (XML) file, and
wherein the XML file includes information identifying functions for controlling the appliance.
